(19) United States
(12) Patent Application Publication
(10) Pub. No.: US 2005/0143066 A1
(43) Pub. Date: Jun. 30, 2005

(54) Personalization of telecommunications services

(76) Inventor: Kari J Niemi, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/511,103

(22) PCT Filed: Apr. 10, 2003
(86) PCT No.: PCT/FI03/00271

(30) Foreign Application Priority Data
Apr. 15, 2002 (FI) 20020728

(51) Int. Cl. H04Q 7/20

(52) U.S. Cl. 455/432.3; 455/414.1

(57) ABSTRACT

A method for personalizing services in a mobile communications system, the services being used on the basis of a parameter list (pam-1, pam-N) and a service data profile (1-1, 1-2, 1-3, N-1, N-2). The parameter list comprises the parameters needed for providing a service. The service data profile defines levels for the parameters in the parameter list, the parameter values being re-trieved from the levels when the service is being used. The levels include, for example, global (gl), service-specific (se) and subscriber-specific (su) levels. The service data profiles of a particular service differ from one another accord-ing to the level on which the parameter values have been defined.

### BACKGROUND OF THE INVENTION

The invention relates to services available in telecommunications networks, and particularly to the personalization of services provided by third generation mobile communications networks. Another term that can be used for service personalization is service differentiation.

Personalization is used to provide users with as customized services as possible according to their needs. Different users are interested in different kinds of services available in telecommunications networks. Therefore, there is a need to modify services to suit the needs of different user groups based on an agreement made to this effect between a service provider and a subscriber. At the moment it is possible to provide service-specifically differentiated services. Consequently, from the system point of view the modification of services so as to make them suit different targets or target groups requires the creation of a new service. This causes redundancy in service logic and service data, because the new service may be basically similar to existing services and only comprise a few differing characteristics. Even a minor differentiation of a service may occupy personnel resources and system capacity, as well as cause problems in system management.

The problem, therefore, is that at the moment there are only limited possibilities for flexible and expedient service personalization, and only certain subscriber-specific parameters can be determined for a service. This creates a need for developing possibilities for service personalization.

### BRIEF DESCRIPTION OF THE INVENTION

It is therefore an object of the invention to provide a method and equipment implementing the method which allow the above problem to be solved. This object is achieved by a method, system, software product and network nodes characterized by what is stated in the independent claims. The preferred embodiments of the invention are disclosed in the dependent claims.

The invention is based on the idea of personalizing services by means of what are referred as service data profiles. This means that a service-specific service data profile is determined for the subscription of a service subscriber. The service data profile comprises service parameters associated with the service, and definitions of the parameters. A service data profile defines how individualized the determination of each service parameter value is in the service data profile in question. The underlying idea is that a service parameter value may be determined to be subscription-, subscriber-, group-subscription-, or group-specific, for example. A service parameter value that is determined as subscriber-specific, for example, is thus more individualized than a group-specific service parameter value. A single service may be assigned a plural number of service data profiles, which differ from one another in that one or more service parameter values of a service data profile are defined differently (with a higher or lower rate of individualization) in that profile than in other service data profiles associated with the same service.

An advantage of the method and system of the invention is that service differentiation becomes a dynamic process, i.e. different service data profiles are assigned different targets or target groups. This allows services to be modified in a flexible and expedient manner, while at the same time system capacity is saved.

### BRIEF DESCRIPTION OF THE DRAWINGS

In the following, the invention will be described with reference to the preferred embodiments and the accompanying drawings, in which

FIG. 1 illustrates a system of the invention;

FIG. 2 is a block diagram illustrating service data included in a home subscriber server according to a first preferred embodiment of the invention;

FIG. 3 is a block diagram illustrating service data included in a service database according to the first preferred embodiment of the invention;

FIG. 4 is a block diagram illustrating service data included in a service database according to a second preferred embodiment of the invention;

FIG. 5 is a block diagram illustrating service data included in a service data base according to a third preferred embodiment of the invention;

FIG. 6 is a block diagram illustrating service data associated with a profile-specific logic according to a fourth preferred embodiment of the invention;

FIG. 7 is a flow diagram illustrating operation according to the first preferred embodiment of the invention.

### DETAILED DESCRIPTION OF THE INVENTION

In the following, the preferred embodiments of the invention will be described with reference to a third generation mobile communications system, such as the UMTS (Universal Mobile Communications System). However, the invention is not meant to be restricted to these embodiments. The invention can also be applied in other telecommunications systems in which subscription data is maintained for producing user services. Due to the rapid development of telecommunications systems, additional modifications may be required to the invention. The words and expressions used herein should therefore be interpreted in their broadest sense, as they are meant to illustrate the invention and not to restrict it. The most essential aspect of the invention is the functionality concerned, not the equipment or network element executing it.

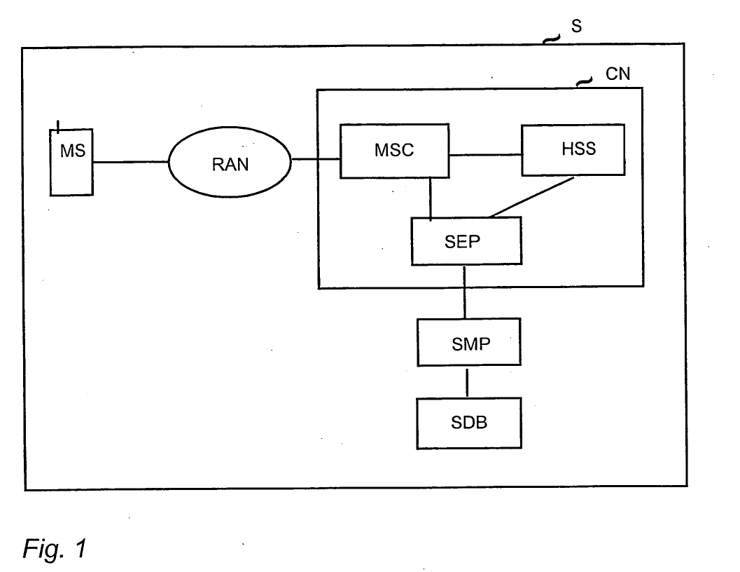

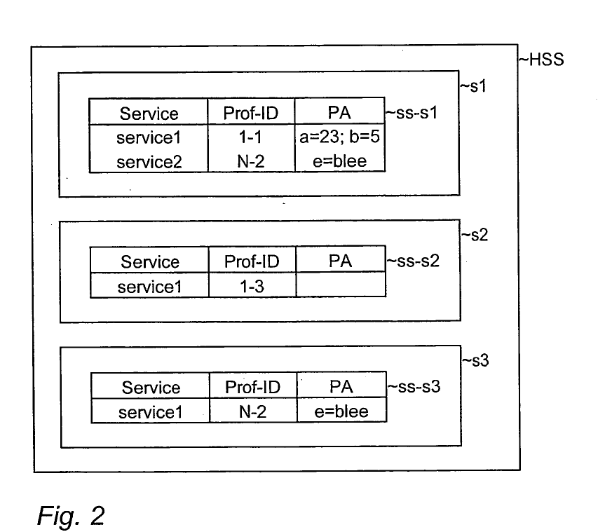

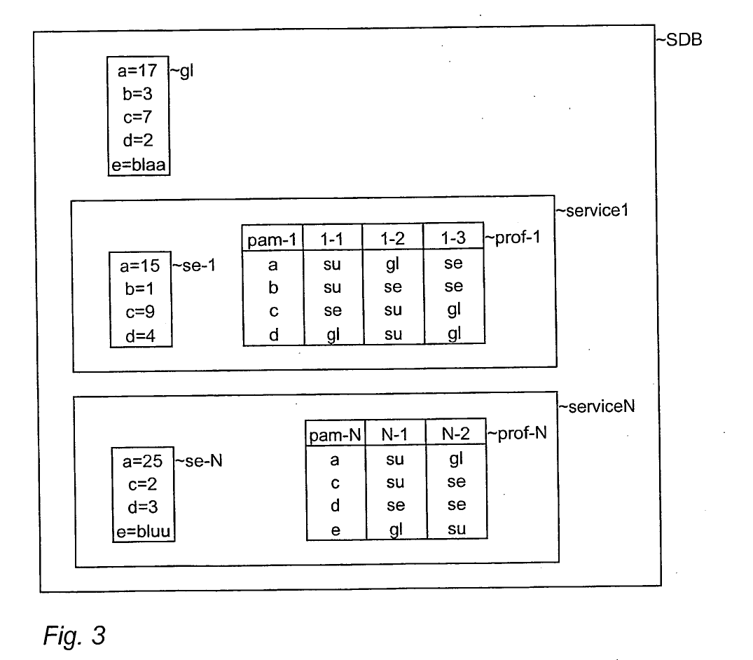

FIG. 1 illustrates a mobile communications system S of a first preferred embodiment of the invention, the system comprising a user terminal (mobile station) MS located within the coverage area of the system and communicating over a radio access network RAN with a mobile services switching centre MSC belonging to a core network CN. A home subscriber server HSS represents a database element in which data concerning subscribers and their subscriptions are stored. FIG. 2 illustrates an example of service-related data of the first preferred embodiment of the invention stored in the HSS. A service database SDB comprises data relating to the services available in the system and service data profiles associated with the services. FIGS. 3 to 5 illustrate examples of service-related data of the preferred embodiments of the invention that reside in the service database. The service database is managed through a service management point SMP. The services are provided on a software basis on a service platform of the serving core network, the program executing the service by retrieving the necessary data from the HSS, via the MSC, and from the SDP, via the SMP, to the service platform, which provides the service. The service platform may be for example an SEP (service execution platform). FIG. 1 only shows the network elements that are relevant to the invention. A person skilled in the art will find it apparent that a mobile communications system also comprises other functions and structures, which do need to be described in greater detail herein.

FIGS. 2 and 3 illustrate how service data of the first preferred embodiment of the invention are maintained in the system. The first preferred embodiment assumes that service data profiles are determined using three different levels and that service parameter values of a subscriber-specific level are stored in the subscriber data residing in the home subscriber server HSS, whereas other service parameter values are stored in the service database SDP. When a service is to be provided, the related service parameter values are retrieved from the HSS and/or the SDB, depending on the level they have been assigned in the service data profile.

FIG. 2 shows an example of the service data of the first preferred embodiment of the invention that reside in the HSS. In the example of FIG. 2, subscribers s1, s2 and s3 have service subscriptions ss-s1, ss-s2 and ss-s3 stored in the HSS for subscribing to services service1 and/or serviceN. Service1 of subscriber s1 is associated with service data profile 1-1, and that of subscriber s2 with service data profile 1-3. The same service data profile can be defined for a plural number of subscribers. ServiceN of subscribers s1 and s3 is associated with service data profile N-2. Under PA, subscriber-specific service parameter values have been stored for subscribers s1, s2 and s3.

FIG. 3 shows an example of the service data of the first preferred embodiment of the invention that are stored in the service database SDB. For the sake of clarity, assume that the service parameters are divided into three levels: global (general), service-specific and subscriber-specific, although other levels are also possible. Examples of logical levels possibly applied include the following:
1.1 global
1.2 service
1.3 service data profile
2.1 group
2.2 group subscription
2.3 subscriber
2.4 subscription

Of these, items 1.1 and 1.2 represent general levels, while other items are differentiated levels. On the other hand, items 1.1, 1.2 and 1.3 can be thought to represent system- and service-specific data, whereas items 2.1, 2.2, 2.3 and 2.4 represent subscription-specific data. Increasing level numbering indicates increasing amount of service-related data in the system. The step from one level to another should preferably be designed sufficiently small, without no major leaps, because otherwise overlapping of data will occur or, if overlapping is to be avoided, restrictions to services will appear. Increasing level numbering also indicates increasing degree of individualization. In other words, here the subscription-specific level is the most individualized level, while the global level is the least individualized one. The more individualized the level, the more individualized is the service parameter value relating to the level, and, hence, service personalization can be carried out.

In the example of FIG. 3, the SDB comprises both global level values and service-specific definitions for service parameters a, b, c, d and e. The global values are service parameter values that are available to the whole system. The service-specific level comprises service1-specific data in block service1 and serviceN-specific data in block serviceN. The service-specific parameter values of service1 are given in block se-1, and the service-specific values of serviceN in block se-N. The service data profiles associated with service1 are shown in block prof-1 and those associated with serviceN in block prof-N. Service1 is provided with service parameter list pam-1, and serviceN with service parameter list pam-N. The service data profiles associated with service1 are 1-1, 1-2 and 1-3, while the service data profiles associated with serviceN are N-1 and N-2. The service data profiles comprise definitions for the parameters in the service parameter list and the level of the service parameter value that is to be used for providing a service for a particular service data profile. The abbreviation “su” refers to a subscriber-specific level, “se” to a service-specific level, and “gl” to a global level.

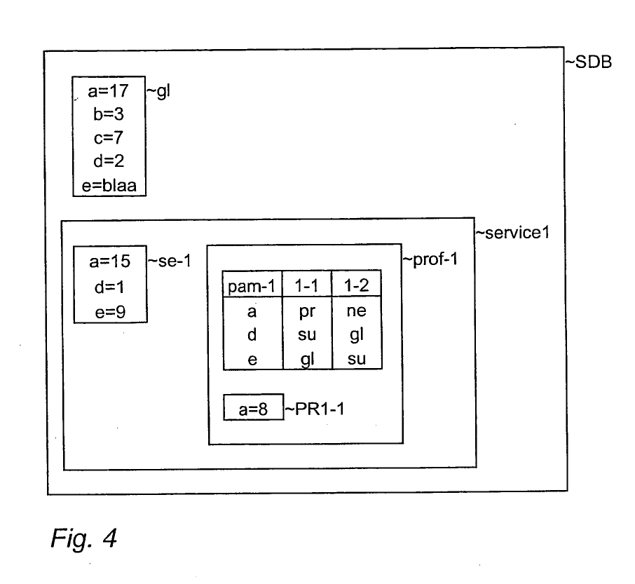

FIG. 4 illustrates the maintaining of service data in the service database SDB in accordance with a second preferred embodiment of the invention. The second preferred embodiment assumes that service parameters are divided into four levels: global, service-specific, profile-specific and subscriber-specific, although other levels are also conceivable.

In the example of FIG. 4, service1 illustrates a service in which the service data profiles also differ according to their service parameters. In the second preferred embodiment of the invention this is made possible by indicating in the service data profile the service parameters that are not available for the service data profile in question. This means that although the service data profiles have different parameters, the structure of the service data profile remains static. This is illustrated in FIG. 4, where service parameter a is defined as non-existent, “ne”, for service data profile 1-2, although service parameter a is included in the service parameter list pam-1 of service1. Further, service parameter a is defined as a service-data-profile-specific (“pr”) parameter in service data profile 1-1. The values of the service-data-profile-specific service parameters of service1 in service data profile 1-1 are defined in block PR1-1. In this case, there are no service-data-profile-specific values determined for service data profile 1-2.

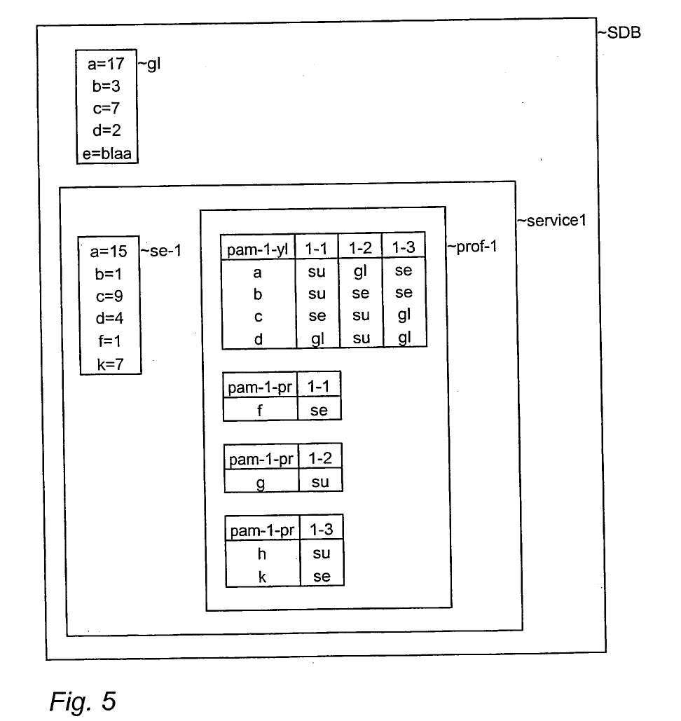

FIG. 5 illustrates the maintaining of service data in the service database SDB in accordance with a third preferred embodiment of the invention. The example in FIG. 5 is based on the same division into levels as the example in FIG. 3. According to the third preferred embodiment of the invention, service data profiles 1-1, 1-2 and 1-3 comprise a general part pam-1-yl, which includes service parameters common to all the service data profiles of service1, and a profile-specific part pam-1-pr, which includes other service parameters associated with the service data profile concerned. In this embodiment, the structure of the service data profile is not static, i.e. it is not the same for all service data profiles of a particular service, but depends on the structure of the profile-specific part.

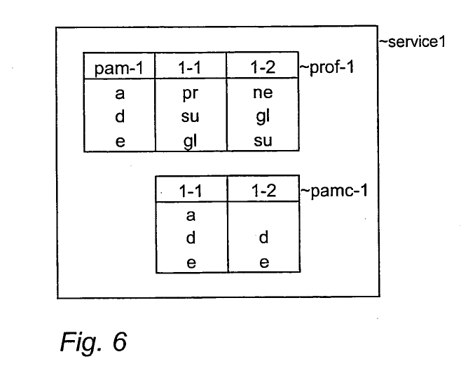

FIG. 6 illustrates the maintaining of service data in the service database SDB in accordance with a fourth preferred embodiment of the invention. The example in FIG. 6 is based on the same division into levels as the example in FIG. 4. According to the fourth preferred embodiment of the invention, there is provided a service logic that comprises a service-data-profile-specific program part, which is only executed when the service data profile comprises one or more service-data-profile-specific service parameters. In other words, the service logic consists of a common logic part and a profile-specific logic part. In the example of FIG. 6, pam-1 is the service parameter list of the service1 and comprises service parameters a, d and e. Service1 is associated with service data profiles 1-1 and 1-2. Service parameter a is a profile-specific parameter of service data profile 1-1, and therefore it is not available in service data profile 1-2. According to the fourth preferred embodiment of the invention, the service data profiles 1-1 and 1-2 have different service logics. The service logics associated with service1 are described in service parameter lists pamc1-1 and pamc1-2. Pamc1-1 relates to service data profile 1-1 and it comprises all service parameters of pam-1. Pam-2 relates to service data profile 1-2 and it comprises only service parameters d and e of pam1, because service parameter a is not in use in service data profile 1-2. This ensures that the service logic does not contain any reference to service parameters not associated with the service data profile in question.

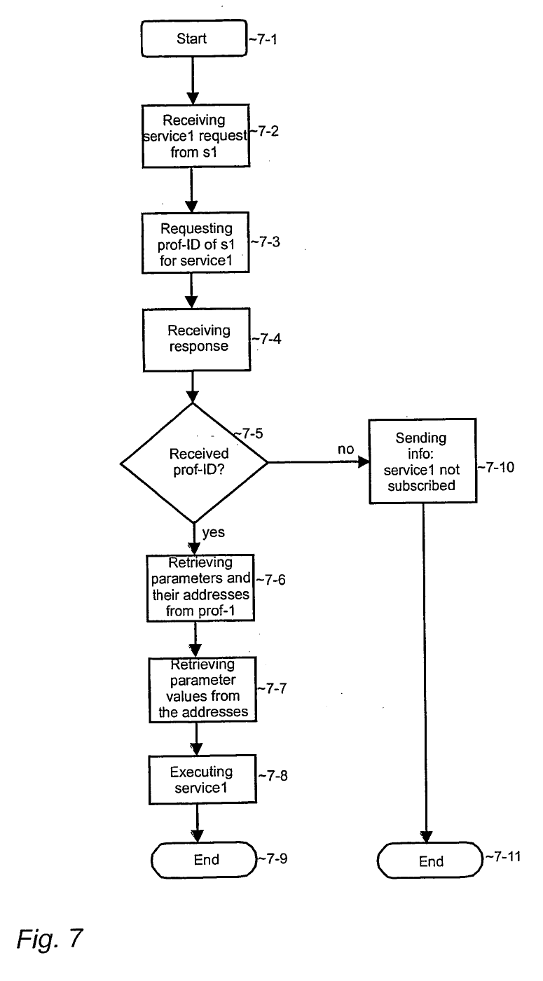

FIG. 7 is a flow chart illustrating the operation of a service platform SEP according to the first preferred embodiment of the invention. In step 7-2, a request for service1 is received from subscriber s1. Next, in step 7-3, the HSS is requested to provide the service data profile identifier (prof-ID) relating to service1 of s1. In step 7-4 a response to the request made in step 7-3 is received from the HSS. In step 7-5 the routine checks whether the response of the HSS contains the prof-ID. If no prof-ID was received in step 7-4, then there is no subscription for service1. This is informed to the user in step 7-10, and the requested service is not executed. If the prof-ID was received in step 7-4, the service parameters and their addresses are retrieved in step 7-6 from the service data profile associated with the identifier. In step 7-7, the service parameter values are retrieved from the location in the HSS and/or SDB, as indicated by the levels defined in the service data profile. After this, the service is executed. According to the example of FIGS. 2 and 3, for example, subscriber s1 would receive service1. On the basis of FIGS. 2 and 3, service1 would be provided to subscriber s1 using the following service parameter values:
a=23, b=5, c=9 and d=2.

The service parameter values are deduced as follows. The parameter list of service1 comprises service parameters a, b, c and d. The data stored in the HSS relating to subscriber s1 show that service1 is associated with service data profile 1-1. The data stored in the SDB in turn show that service parameters a and b of 1-1 are subscriber-specific (su) by definition, parameter c is service specific (se), and parameter d is global gl).

In other words, the service profile defines the level of each service parameter value determined for the service data profile in question. At the same time, the location where the parameter value is to be found is determined. In other words, the service data profile comprises service-related parameters and their definitions on logical levels. A service data profile is always used to refer to a single service. A single service, on the other hand, may be associated with different service data profiles, and one and the same service data profile may be associated with a plural number of subscribers or subscriptions.

In this specification the term ‘subscriber’ refers to a single subscriber and/or group, and the term “subscription” to the subscription of a single subscriber and/or to a group subscription.

In this specification the term “list” is to be understood as broadly as possible such that it does not have to concern a physical list, but the information (parameters) of the list may have a distributed location in the system. It suffices that the system knows the parameters associated with the service.

Although FIGS. 3, 4 and 5 show three different ways of determining service data profiles, a person skilled in the art will find it apparent that a mobile communications system operator may accept various ways, or just one way, of defining the profiles.

Although the invention is described above assuming that subscriber-specific parameter values are stored in the subscriber data, while all other values and definitions associated with service data profiles are stored in the service database, a person skilled in the art will find it apparent that it is not relevant where the definitions and values are stored. Subscriber-specific values, for example, may be stored in the service database, or global service parameter values in a separate database. It suffices that the network node providing the service knows the level division applied and where to find the service data profile, and that the service data profile determines the service parameters to be used and the levels involved.

A system implementing the functionality of the invention and its network nodes comprise not only prior art means but also means for determining service data profiles, for storing service parameter values and for executing a service according to a service data profile. A serving network, network nodes and terminal device comprise processors and memory that can be utilized in the functionalities according to the invention. Any modifications required for implementing the invention may be provided by adding or updating the necessary software routines in those network elements into which the services are to be loaded. Network elements carrying out data storage may also require additional memory capacity.

It is apparent to a person skilled in the art that as technology advances, the basic idea of the invention may be implemented in various ways. The invention and its embodiments are therefore not restricted to the above examples, but they may vary within the scope of the claims.

1. A method for personalizing a service in a telecommunications system, the method comprising at least the steps of
maintaining a parameter list for a service, the list comprising parameters associated with the service,
further comprising the steps of
maintaining a value on at least two different levels for at least a first parameter, the first level being more individualizing than the second level; and
maintaining at least two service data profiles for the service, the profiles both comprising definitions of the levels for the parameters and the profiles differing from one another at least in that in the first service data profile the first parameter value is on the first level, whereas in the second service data profile it is on the second level.

2. A method according to claim 1, comprising the steps of
indicating the service data profile to be used for providing a service to a subscriber in subscriber data residing in the system; and
providing the service to the subscriber by using the values defined for the parameters on the levels according to the service data profile definitions.

3. A method according to claim 1, wherein the first level is a system- or service-specific level and the second level is a subscription-specific level in which a parameter value is separately defined for each subscription in the system.

4. A method according to claim 1, wherein the parameters of the parameter list that are not available for a particular service data profile are indicated in the service data profile.

5. A method according to claim 1, further comprising the step of determining in the service data profile not only common parameters included in each service data profile, but also service-data-profile-specific parameters that relate only to the service data profile in question.

6. A method according to claim 1, further comprising the step of maintaining a parameter list for a service, the list being associated with the first service data profile and comprising references only to parameters associated with the first service data profile.

7. A telecommunications system software product comprising a computer-readable program stored in a program storage means, the program comprising a first routine for maintaining a parameter list for a service, the list comprising parameters associated with the service, wherein the program comprises a second routine for maintaining at least a first parameter value on at least two different levels, the first level being more individualizing than the second the profiles both comprising definitions of the levels for the parameters and the profiles differing from one another at least in that in the first service data profile the value of the first parameter is on the first level, whereas in the second service data profile it is on the second level.

8. A software product according to claim 7, wherein the program comprises a fourth routine to indicate in the system subscriber data the service data profile to be used for providing a service to the subscriber, and a fifth routine for providing the service to the subscriber by using the parameter level values defined on the basis of the service data profile definitions.

9. A software product according to claim 7, wherein the program further comprises a routine for identifying those parameters in a parameter list which are not available in the service data profile.

10. A software product according to claim 7 wherein the program further comprises a routine for identifying in the service data profile not only common parameters included in each service data profile, but also service-data-profile-specific parameters that relate only to the service data profile in question.

11. A software product according to claim 7, wherein the program further comprises a routine for maintaining for the service a parameter list associated with the first service data profile, the list including references only to parameters associated with the first service data profile.

12. A telecommunications system comprising
a network node for maintaining for a service a parameter list of parameters associated with the service,
wherein the system is configured to
maintain at least a first parameter value on at least two different levels, the first level being more individualizing than the second level; and to
maintain at least two service profiles for the service, the profiles both comprising definitions of the levels for the parameters and the profiles differing from one another at least in that in the first service data profile the value of the first parameter is on the first level, whereas in the second service data profile it is on the second level.

13. A telecommunications system according to claim 12, wherein the system is further configured to
indicate in the system subscriber data the service data profile to be used for providing the service to a subscriber; and to
provide the service to the subscriber by using parameter values defined on levels according to the service data profile definitions.

14. A telecommunications system according to claim 12, wherein the system is further configured to indicate the parameters that are not available for the service data profile.

15. A telecommunications system according to claim 12, wherein the system is configured to maintain in the service data profile not only common parameters included in each service data profile but also service-data-profile-specific parameters only associated with the service data profile in question.

16. A telecommunications system according to claim 12, wherein the system is further configured to maintain for the service a parameter list associated with the first service data profile, the list including references only to parameters associated with the first service data profile.

17. A network node for maintaining a parameter list of parameters associated with a service in a telecommunications system, wherein the network node comprises memory means for
maintaining a value for at least a first parameter on at least two different levels, the first level being more individualizing than the second level; and for
maintaining at least two service data profiles for a service, the profiles both comprising parameter level definitions and the profiles differing from one another at least in that in the first service data profile the value of the first parameter is on a first level, whereas in the second service data profile it is on a second level.

18. A network node according to claim 17, wherein the network node is a service database in a mobile communications system.

19. A network node for providing a service in a telecommunications system in which a list of the parameters for the service is maintained, wherein for providing the service to the subscriber, the network node comprises: a first routine to find out in the subscriber data of the system which one of the service data profiles of the service has been subscribed to, the service data profiles comprising definitions of the levels for the parameters and the profiles differing from one another in relation to at least one parameter level definition; and a second routine for retrieving the parameter values from the levels based on the definitions in the service data profile.

20. A network node according to claim 19, wherein the network node is a service platform (SEP) in a mobile communications system.
